(19) United States
(12) Patent Application Publication
(10) Pub. No.: US 2012/0318028 A1
(43) Pub. Date: Dec. 20, 2012

(54) BIPOD LOCK

(76) Inventor: Michael Hahn, Chicago, IL (US)

(21) Appl. No.: 13/163,931

(22) Filed: Jun. 20, 2011

(51) Int. Cl. E05B 67/28; E05B 73/00

(52) U.S. Cl. 70/41; 70/53

(57) ABSTRACT

A lock for securing a bipod against theft, which may include a base, and first and second locking members each connected to the base. The first and second locking members are shaped and designed to lock one or more of the following parts of the bipod to a rigid object: a front wheel, a rear wheel, and a frame. In a preferred embodiment, the locking members include elongated loops, such as elongated arch-shaped members, which are preferably nestable for ease of transportation and storage, and whose distal ends may be removably connected to the base. One or more of the distal ends of the locking members may be permanently attached to the base, so that the locking mechanism may be transported and stored as a single unit. The locking members can preferably pivot relative to the base.

### BACKGROUND OF THE INVENTION

The present invention generally relates to locks for securing bicycles and preventing theft, and may be used whether the bicycles are situated at rest or in transport.

Various devices are known for securing bicycles against theft. Chains have been used for many years. The “U-lock” was introduced in the early 1970s. However, existing bicycle locking devices fail to lock both the front and rear tires securely to the bicycle frame, and also fail to consider the posture of the bicycle left idle. Interviewed bicyclists complained about the damage to their bicycles incurred when the bicycle had fallen or was knocked over while locked to a bicycle rack. In addition, bicyclists had concerns about having to carry multiple locking devices in order to adequately prevent theft of the bicycle and parts of the bicycle, especially the tires. Further, with existing bicycle locking devices, the weight of locks and the requirement for extra keys are also perceived to be a nuisance.

To prevent theft of their wheels, rims and/or tires, bicyclists have developed locking methods of their own, which may be categorized as follows: (1) front-wheel detach methods; (2) lock-and-cable methods; and (3) 2-lock methods. Regarding front-wheel detach methods, the bicyclist either removes the front tire and carries the tire with him/her, or removes the front tire and locks it to the rear tire and/or bicycle frame. Both of these front-wheel detach methods require additional time, extra effort and inconvenience to the bicyclist. Additionally, this method does not restrain the front tire from turning about the axis connecting it to the bike frame, allowing the bicycle to fall over when jostled.

Regarding lock-and-cable methods, bicyclists lock the front tire to the frame with one locking device, and then use a cable to secure the rear tire to the frame. This method has several limitations as well, however, as it requires multiple/separate devices, is vulnerable to theft by cable clipping, and also does not restrain the front tire from turning, allowing the bicycle to topple when jostled.

Regarding 2-lock methods, bicyclists use two separate locking devices (usually similar to each other) to separately secure each tire to the bicycle frame. This method requires carrying multiple locking devices as well as multiple keys, and also fails to restrain the front tire from turning and allowing the bike to topple over when jostled.

Accordingly, it is an object of the present invention to provide an anti-theft bicycle lock that will enable the bicycle user to quickly and securely lock the front and rear tires and the frame of the bicycle. It is another object of the present invention to provide a bicycle lock which is convenient to use, and which does not have a large footprint, so that it may be easily carried such as in a backpack. It is a further object of the present invention to provide a more functional bicycle lock that will prevent the front wheel from turning and retain the bicycle in an upright condition even if jostled, and that will also keep the tires from spinning during bipod transport using (e.g.) a vehicle transport device.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Bipod” means a bicycle, motorcycle, moped or other device used for transport having at least two wheels.

“Loop” means a locking member forming a closed curvilinear or closed polygonal shape (e.g., elongated arch, circle, ellipsoid, square, rectangle, etc., such as but not limited to those loop shapes shown in the drawings here).

### SUMMARY OF THE INVENTION

The objects mentioned above, as well as other objects, are solved by the present invention, which overcomes disadvantages of prior bicycle locks and locking systems, while providing new advantages not previously obtainable with such devices.

In a preferred embodiment, a lock is provided for securing against theft a bipod having at least a front wheel, a rear wheel and a frame. Preferably, the lock includes a base, and first and second locking members that may be each connected to the base. The first and second locking members are together capable of locking the following parts of the bipod to a rigid object: a front wheel, a rear wheel, and a frame.

In a particularly preferred embodiment, the first and second locking members may each constitute a loop, such as an elongated arch, terminating in two ends. Preferably, the loops have different sizes to allow one loop to nest within the other during non-use and transport of the lock.

In one embodiment, the ends of the first locking member may be permanently attached to the base, while a first end of the second locking member may be permanently attached to the base (such as by using a ball-and-socket joint), and a second end of the second locking member may be detachable from the base. In other, perhaps less desirable, embodiments, each end of the locking members may be permanently attached to the base, or each end of the locking members may be removably attached to the base.

By using concentric members, for example, the locking member ends may be allowed to rotationally pivot relative to the base.

In another preferred embodiment, the base includes a locking mechanism enabling the locking and selective removal of at least one of the ends of each of the locking members, to and from the base. Preferably, the locking mechanism only requires a single key.

A method is also disclosed for employing a bipod lock to securely lock a bipod having at least two wheels and a frame to a rigid member. In one such preferred method, a bipod lock is provided that has a base, and first and second locking members connected to the base. The locking members may be elongated, arch-shaped members, or other closed loop shapes. Next, one of the bipod wheels may be locked to the rigid member using the first locking member. Finally, the other bipod wheel and a frame of the bipod may be locked to the rigid member using the second locking member. During the locking process, an additional step may be to ensure that the locking member snugly fits the bipod members that it is securing.

In another preferred embodiment, the locking members may be oriented to form an obtuse angle, and locked in this orientation.

Preferably, the locking members each have two distal ends, and the two distal ends of one of the locking members are removably connected to the base, while one of the two distal ends of the other locking member is permanently connected to the base and the other distal end is removably connected to the base. Preferably, each of the two distal ends of the two locking members is pivotable relative to the base. The base may employ a single keyhole for actuating a locking mechanism for securing the locking members to the base.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a perspective view of one preferred embodiment of the invention which may be used to lock a bicycle to a fixed pole;

FIG. 2 is a perspective view similar to FIG. 1, showing three steps in locking the bicycle using a preferred embodiment of the invention;

FIG. 3 is a top perspective view, partially in cross-section, showing the base interlocking with ends of the locking loops in a preferred embodiment of the invention;

FIGS. 4A-4C are schematic views of alternative embodiments of the present invention;

FIGS. 5A and 5B are schematic top views showing an alternative embodiment of the invention;

FIGS. 6A-6B and 7A-7B are enlarged schematic top views showing a portion of the embodiment shown in FIGS. 5A-5B, including an interior cross-section of the base of the lock of the present invention;

FIGS. 8A-8C are schematic illustrations of alternative embodiments of the invention;

FIG. 9 is a perspective view of another preferred embodiment of the invention which may be used to lock a bicycle to a fixed pole;

FIG. 10 is an enlarged perspective view of a portion of FIG. 9;

FIGS. 11A-11C are successive, partially-sectioned top views of an alternative embodiment of a portion of the invention, showing the base and its interlocking interaction with ends of the two locking loops;

FIG. 12 is a top and side perspective view of another embodiment of the present invention;

FIGS. 12A and 12B are successive, partially-sectioned top views of taken along reference line 12A-12A of FIG. 12;

FIG. 13 is a perspective, partially-sectioned view of yet another embodiment of the invention;

FIG. 13A is a view taken along reference line 13A-13A of FIG. 13;

FIG. 14 is a partial section view of the interface between two of the base members in the embodiment shown in FIG. 13;

FIGS. 14A and 14B are enlarged, successive sectional views of the circled portions of FIGS. 14 and 13A, respectively;

FIG. 15 is a perspective, partially-sectioned view of still another embodiment of the invention;

FIG. 15A is a sectional view along reference line 15A-15A of FIG. 15;

FIG. 15B is a sectional view along reference line 15B-15B of FIG. 15A;

FIG. 16A is a partial perspective view of yet another embodiment of the invention;

FIG. 16B is an enlarged perspective view of a portion of FIG. 16A;

FIG. 16C is an enlarged, partially sectioned view taken along reference line 16C-16C of FIG. 16A;

FIG. 16D is a perspective view of the embodiment shown in FIG. 16, with the inner loop arms rotated 180°;

FIG. 16E is an enlarged perspective view of a portion of FIG. 16D; and

FIG. 16F is a partially sectioned view taken along reference line 16F-16F of FIG. 16D.

The components in the drawings are not necessarily to scale, emphasis instead being placed upon clearly illustrating the principles of the present invention.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

Referring first to FIG. 1, a bipod such as bicycle 20 has front and rear wheels 22, 24 and a frame 26 which may be locked to a fixed post 30, for example, using the preferred embodiment of locking mechanism 10 of the present invention. Using the present invention, other two-wheeled transport devices (termed “bipods” here) may be locked using the present invention, and may be secured to various rigid items other than posts, such as other bipods, transport vehicles, bike stands, or other objects.

Still referring to FIG. 1, bipod locking mechanism 10, in a preferred embodiment, may include two locking loops 12, 14, such as elongated arch-shaped members that connect to a single common base 16. Preferably, one arched member 14 may have a radius that is less than the other, allowing member 14 to evenly nest within member 12 when they are located in the same plane (see FIGS. 4A-4C).

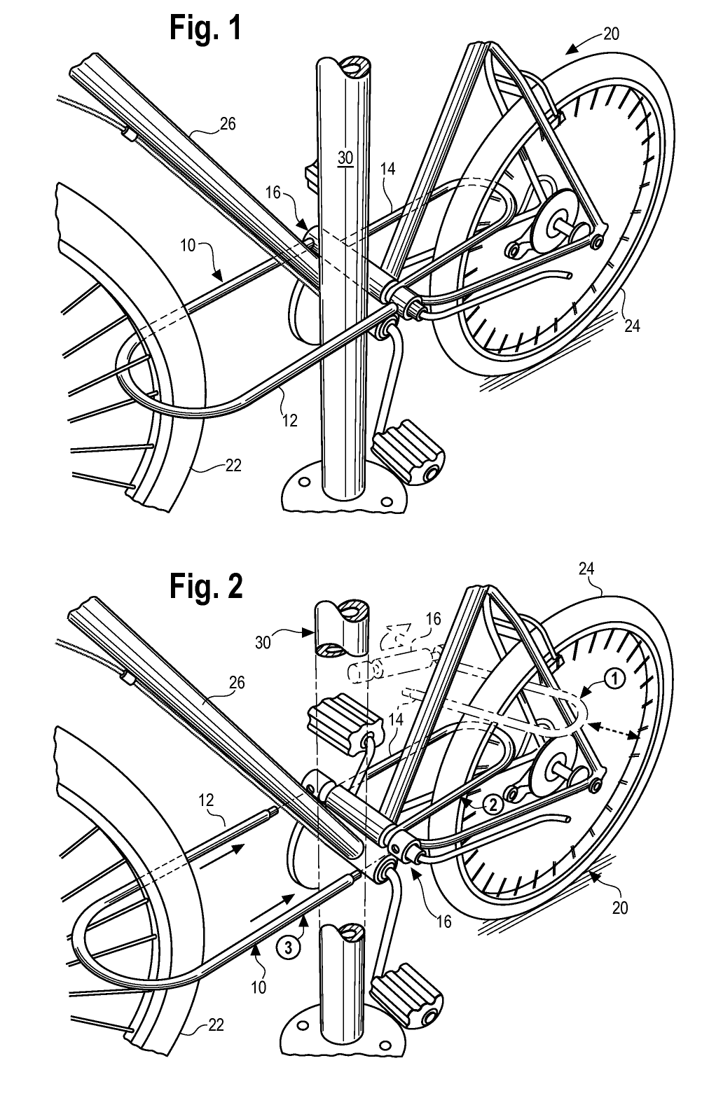

In a preferred embodiment, each arched member 12, 14 may be connect to base 16 by inserting distal ends of the members into ends of the base, as shown in FIG. 2. In one sequential method of using the locking mechanism embodiment shown in FIG. 2, loop/arch-shaped member 12 may be positioned about the rear wheel 24 of a bicycle 20 as shown in location 1 of FIG. 2. Next, the distal ends of locking loop 12 may be inserted into mating apertures on base 16, and loop 12 may be positioned around a portion of the bicycle frame and rear wheel as shown in location 2 of FIG. 2. Finally, one of the ends of larger loop/arch-shaped member 14 may be threaded through front wheel 22, loop 12 may be positioned as shown in location 3 of FIG. 2, and loop 12 may then be locked to base 16 by inserting the distal ends of loop 12 within mating apertures in base 16.

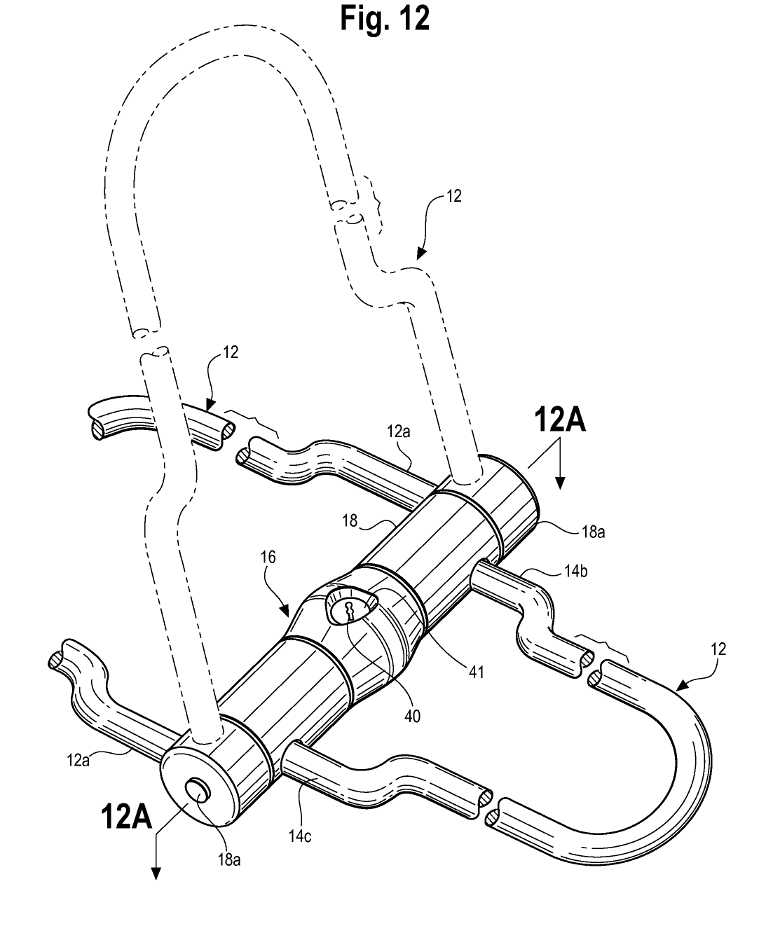

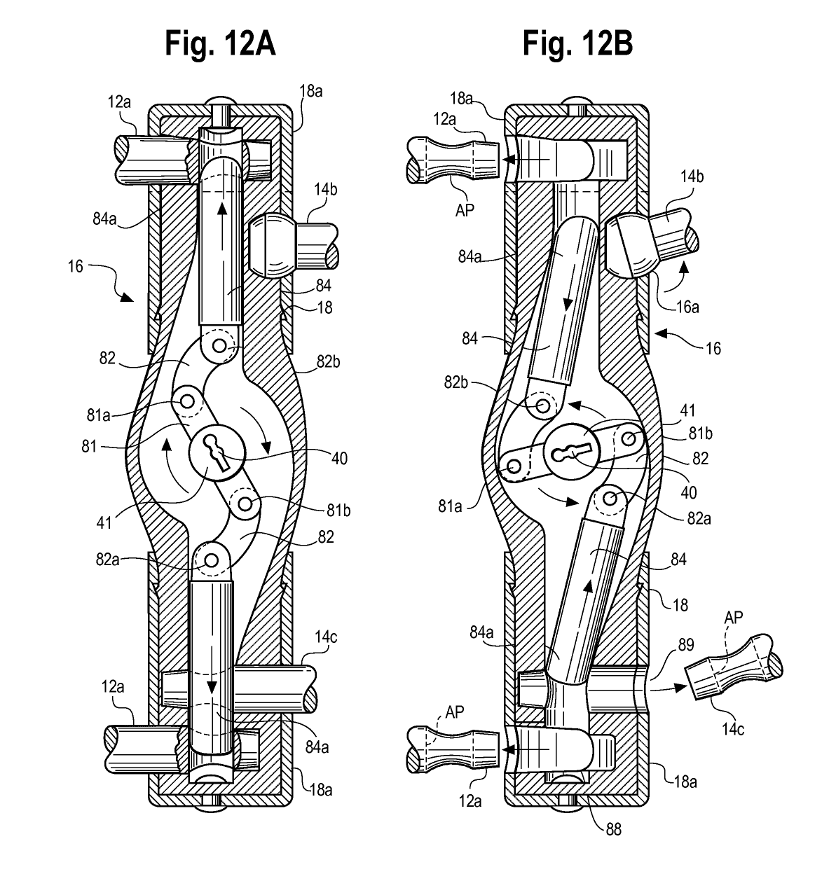

Preferably, to facilitate handy positioning of locking mechanism 10, locking loops 12, 14 can each pivot about the base, as shown by the arrows in FIGS. 4A-4C, and as further explained with reference to the embodiment shown in FIG. 12, for example, below.

In a particularly preferred embodiment, it may be desirable to design a locking mechanism 10 such that one of the locking loops may be completely separated from the base, while the other locking loop may have a first distal end which is detachable from the base, and a second distal end which remains permanently connected to the base. This embodiment limits the number of parts to two, to help prevent owner loss of the locking mechanism. The distal end of the arched member that remains connected to the base may do so by employing a collar or sphere at the tip of the distal end whose diameter is greater than the diameter of the insertion hole in the base. Depending upon the application and desirable features, the outer loop/arm may have the connectivity of the inner loop/arm, or vice-versa.

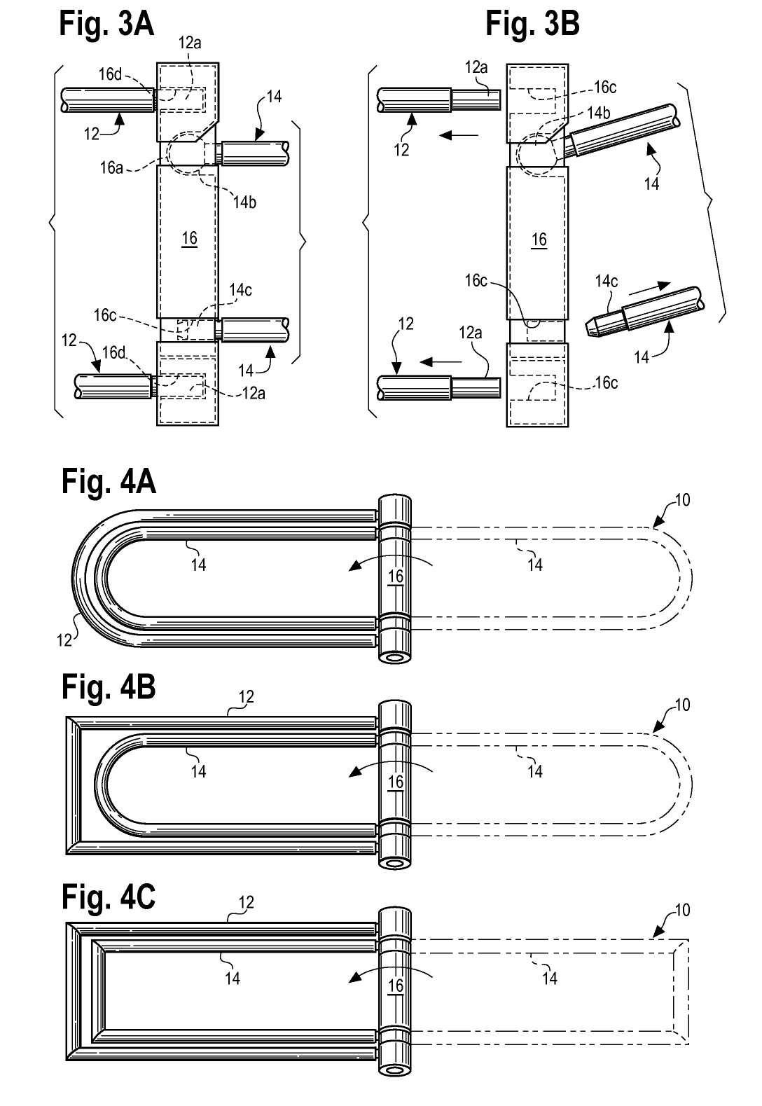

Referring to FIGS. 3A and 3B, one way to provide a loop end with the ability to be permanently coupled to the base while accommodating a large range of motion in multiple planes relative to the base is to employ a locking loop 14 which may terminate in a ball 14b, pivotable within base socket 16a, such that loop ball 14b is not removable from base socket 16a, whereas the opposing end 14c of loop 14 may be removable from corresponding base socket 16c. Similarly, opposing distal ends 12a of the other loop 12 may also be removably attached to base apertures 16d.

It will be appreciated that the dimensions of locking loops 12, 14 may be chosen to balance these competing concerns: (1) portability of the preferably nestable locking mechanism (such as in a backpack); and (2) ensuring that each loop is sufficiently large so it can extend to lock about a tripartite combination consisting of: a front/rear wheel, a bipod frame and a rigid member (e.g., a post). Referring to FIGS. 4A-4C, locking loops with different configurations (elongated arch and rectangular combinations) are shown. Alternative configurations, such as elliptical, circular, or other configurations, may be used and still fall within the principles and claims of the present invention.

It will also be appreciated that locking mechanism 10 may be employed when transporting bipods, such as bicycles located on a transportation storage rack, which may be attached to the outside of a motor vehicle. Using locking mechanism 10, both front and rear bicycle tires may be secured to the frame, making theft difficult. Additionally, use of locking mechanism 10 will prevent the tires from spinning, which will ordinarily occur due to wind resistance encountered while the motor vehicle is in transport.

Use of locking device 10 can also render the bipod's posture more rigid and restrain its handle bars from moving. This will prevent the bipod from falling while it is locked, even if it is jostled by owners attempting to lock their bipods in adjacent locations, for example. The following embodiment explains one way in which locking mechanism 10 may be used to retain the bipod's posture in an upright condition.

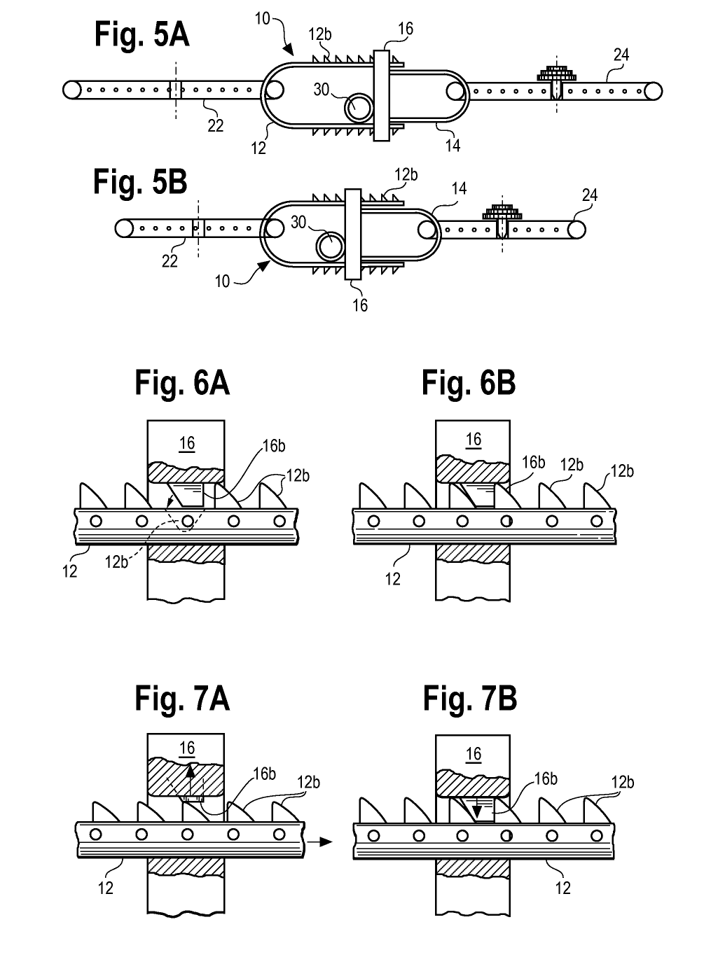

Referring now to FIGS. 5A-5B, 6A-6B and 7A-7B, the exterior of one of the loops, such as the larger loop 12, may be provided with teeth 12b, that can mate with teeth 16b located within the interior of base 16, such that as loop 12 passes into the mating apertures in base 16 in the direction of the arrow as shown in FIGS. 6A and 7A, loop teeth 12b will mesh with base tooth 16b, allowing the owner/user to selectively locate and lock loop 12 within a desired position relative to base 16. This allows the owner/user to secure the loop into a snug fit with a bipod wheel, ensuring that the wheel will not turn while it is in the locked position, to prevent the bipod from falling.

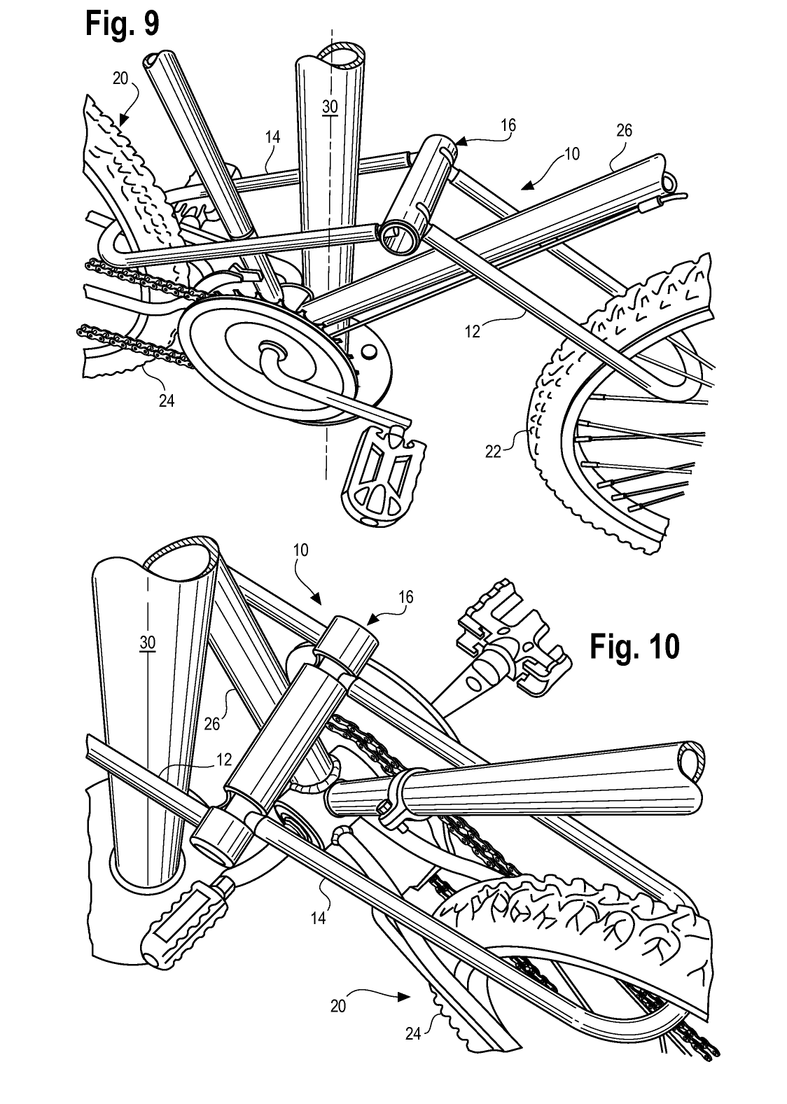

Referring to FIGS. 9-10, it will be appreciated that the width and length of the lock loop securing the rear wheel (the “rear wheel loop”), as well as the width and length of the lock loop securing the front wheel (the “front wheel loop”) may be designed to snugly restrain the bipod in an idle, upright and locked mode. In this regard, it has been found that the distance between the inside of the rear wheel loop and the outside dimension of the wheel/tire is particularly important in determining the extent of the swiveling of the front wheel/tire. It will be understood from FIG. 9 that the bipod lock of the present invention can accommodate bipods having varying wheel sizes and/or bike lengths, simply by rotating the loops as desired, and locking them in position such as by using the locking mechanism shown in FIGS. 5-6.

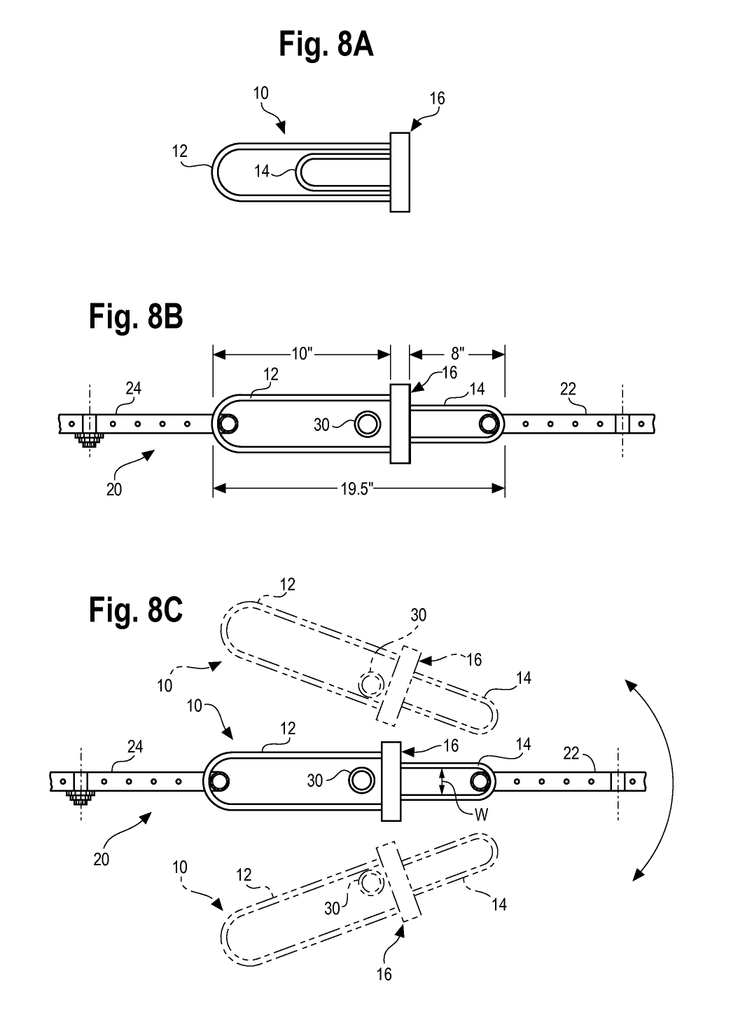

Referring now to FIGS. 8A-8C, once the restraints for the largest and smallest bike tire widths and tire and frame configurations are determined, lock dimensions for a (nearly) “one-size-fits-all” configuration may be determined, if desired. These average lock dimension ranges have been found optimum for fitting most bike dimensions: large loop: overall length of 10 inches; width of 6 inches; arc radius: about 3 inches; small loop: overall length of 8 inches; width of 4 inches; arc radius: about 2 inches. Referring to FIG. 8C, it can be seen that the location of post 30 relative to the larger loop 12, for example, may change depending on how the locking mechanism is arranged, but that if the smaller loop snugly fits front tire 14, the front tire will not rotate excessively and the bipod will remain upright, even if jostled.

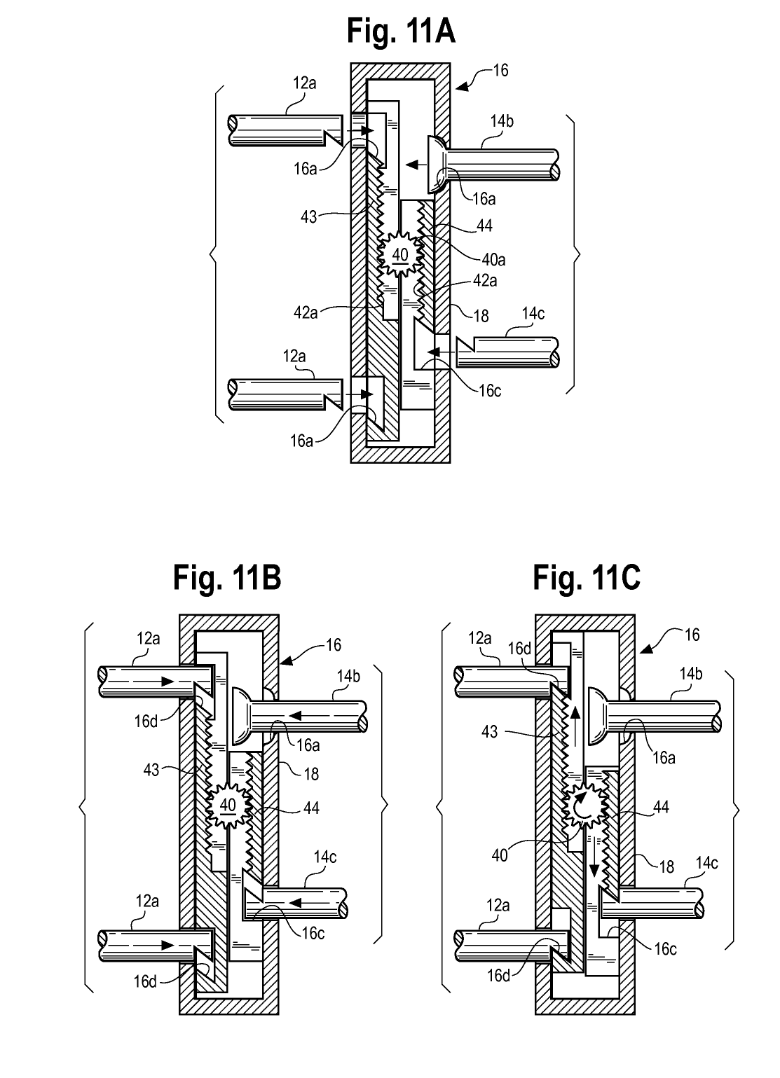

Referring now to FIGS. 11A-C, a preferred internal locking mechanism for base 16 will now be described. Base 16 may include exterior base housing 18, with four apertures 16a, 16c, 16d and 16d. In this embodiment, three of the loop distal ends (12a, 12a and 14c) may include an end with a certain (e.g. notched) end configuration that may be moved into locking orientation with a correspondingly-sized base aperture. In this embodiment, a single keyhole 40 may be used to actuate movement of opposing teeth, carried by opposing moveable cams 43, 44. In the “neutral” or “open” position shown in FIG. 11A, loop distal ends 12a and 14c may be introduced into corresponding base apertures 16d, 16c. At this point, shown in FIG. 11B, a single key (not shown) may be inserted into keyhole 40 and the key and keyhole may be rotated clockwise. Now, as shown in FIG. 11C, this rotation causes keyhole teeth 40 to rotate, in turn moving cam teeth 42a and causing cams 43, 44 to move in the directions shown by the arrows, securely locking loops 12, 14 within base 16. Those skilled in the art will appreciate that other locking mechanisms may be employed to removably lock (preferably three of) the loop distal ends within the base (although all four loop distal ends may be removably locked to the base, if desired in an alternative embodiment). The embodiment shown in the drawings has the advantage of only requiring the owner/user of locking mechanism 10 to carry a single key to actuate the locking mechanism.

Referring now to FIGS. 12, 12A and 12B, another embodiment of locking mechanism 10 is shown. In this embodiment, a single keyed entry 40 enables clockwise rotation of center pin 41, causing arm 81 to rotate, locking loop ends 12a and 14b, 14c within base 16. To unlock the loop ends from the base, a key is inserted into entry 40 and rotated counterclockwise, causing pin 41, and arm 81, to rotate in the same direction. Arms 82 are caused to rotate in this same direction, as shown in FIG. 12B, pivoting at pins 81a, 81b, and urging arms 84 in the direction of the arrows shown in FIG. 12B. The distal ends 84a of arms 84a will thus disengage from corresponding apertures AP in loop ends 12a and 14c (in this embodiment, the ball end of loop 14b may remain pivotably connected to base housing socket 16a). With this embodiment, it will be understood that the loop ends may thus be allowed to pivot about the base when loop ends 12a, 14c are within corresponding bores 87, 88, 89 of the base, and arm ends 84a are located within apertures AP of loop ends 12a, 14c, so that housing caps 18a can rotate relative to the main portion of housing 18.

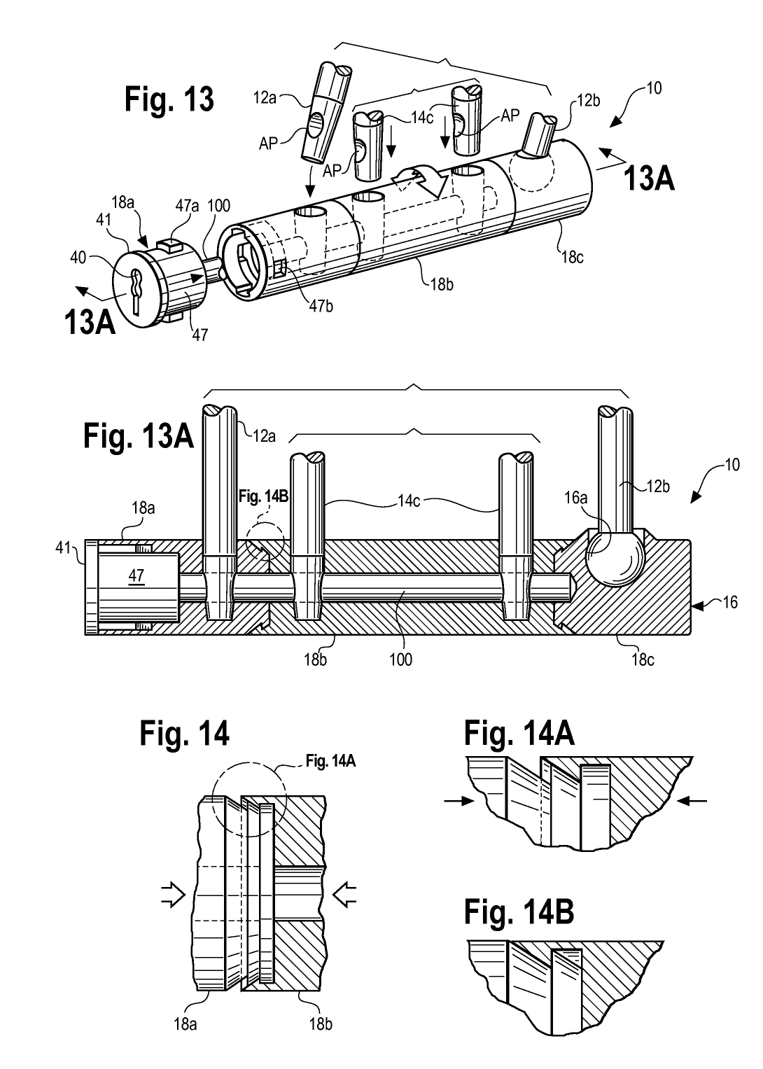

Referring now to FIGS. 13-14, yet another embodiment of the invention is shown. In this embodiment, base 16 includes three interlocking housing sections 18a, 18b and 18c, each of which can rotate relative to the other. These sections may be snap-fit together, as shown in FIGS. 14, 14A and 14B, or may be connected in any other expedient or desirable manner. In this embodiment, disc 41 and keyed entry 40 are connected to locking mechanism 47, which form a rotating end cap 18a. Locking mechanism 47 is connected to main pin 100, which runs through each of the bores for the ends of the loops (12a, 12b and 14c) when bipod lock 10 is fully engaged and locked. Loop end 12b may include a ball joint permanently and pivotably connected to a corresponding socket 16a in base section 18c.

Referring to FIGS. 13 and 13A, housing section 18a may include retractable tabs 47a, which may be retracted from the exterior of the housing when a key engages entry point 40, disengaging tabs 47a from apertures 47b and allowing housing 18a to be uncoupled from housing 18a. When the key is inserted and the locking mechanism is so disengaged, pin 100 may then be removed, allowing three of the loop ends (12a and 14c) to be removed from the base. Of course, those of ordinary skill in the art will appreciate that modifications may be made to this embodiment, as well (e.g., the ball-and-socket joint may be any other of the loop ends, the rotating base portions may be interconnected in other ways, etc.).

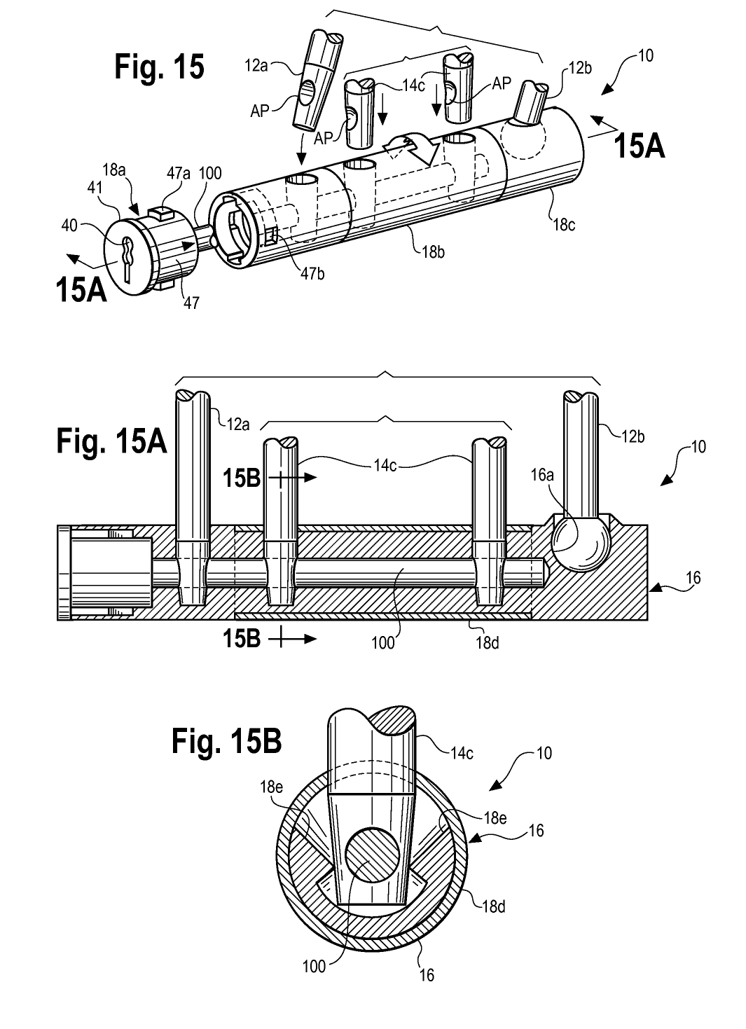

Referring now to FIGS. 15, 15A and 15B, another embodiment of the invention is shown, similar to that shown in FIGS. 13-14. In this example, however, instead of the central housing section rotating about a centerline relative to left and right housing sections (as in FIGS. 13-14), base 16 is an integral piece; however, a central section of base 16 has a reduced cross-section which may be covered by a sleeve 18d, as shown in FIGS. 15A and 15B. The reduced cross-section may end at locations 18e (FIG. 15B), giving loop arms 14c a predefined rotational swing.

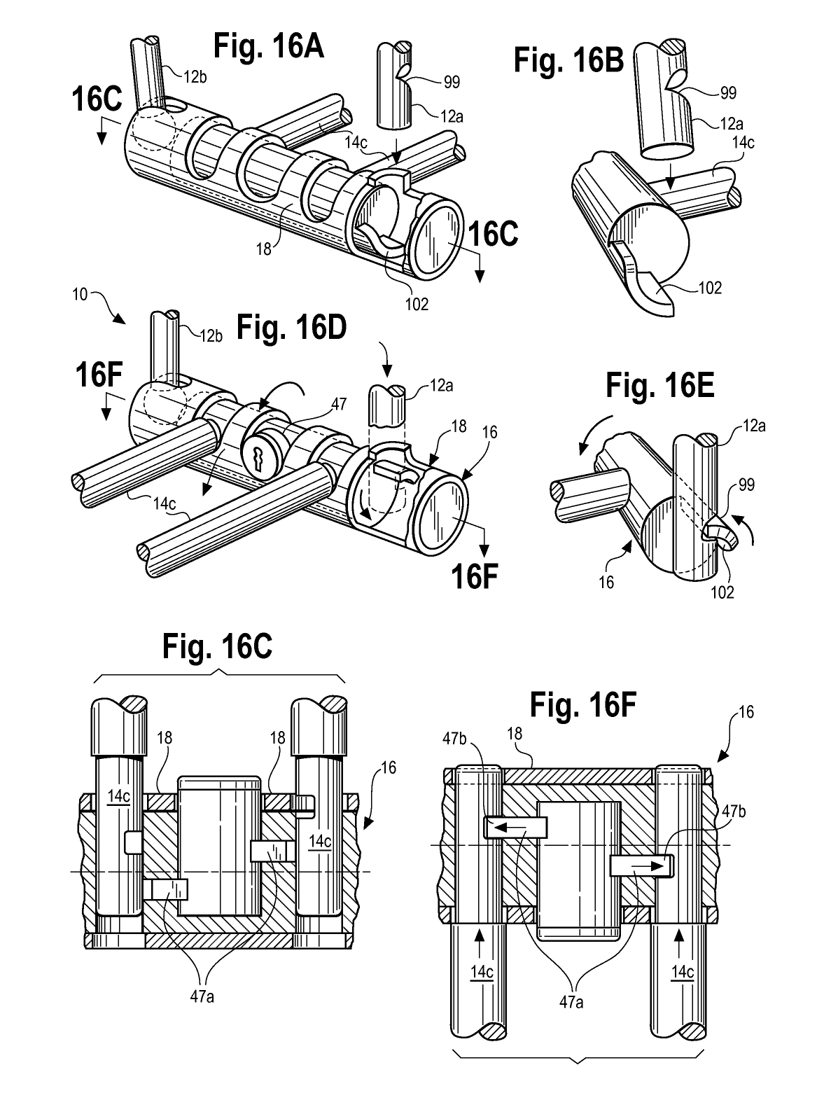

Referring now to FIGS. 16A-16F, still another embodiment of the invention is shown. In this embodiment, with inner loop ends 14c engaged to the base as shown in FIG. 16A, the outer loop end 12a may be inserted into the base, and now the inner loop ends may be rotated as shown in FIG. 16D. This causes tab 102 (FIG. 16B) on the base to engage skived-out portion 99 of outer loop end 12a, locking end 12a in position relative to the base. Referring to FIGS. 16C and 16F, inner loop ends 14c may be unlocked/disengaged (FIG. 16C) or locked/engaged (FIG. 16F) when the key is inserted and lock 47 is rotated (causing tabs 47a to both simultaneously retract (FIG. 16C) or extend in the direction of the arrows (FIG. 16F).

The above description is not intended to limit the meaning of the words used in the following claims that define the invention. For example, while various preferred and less preferred embodiments have been described above, persons of ordinary skill in the art will understand that a variety of other designs still falling within the scope of the following claims may be envisioned and used. It is contemplated that future modifications in structure, function or result will exist that are not substantial changes and that all such insubstantial changes in what is claimed are intended to be covered by the claims.

1. A lock for securing against theft a bipod having at least a front wheel, a rear wheel and a frame, comprising:
a base; and
first and second locking members each connected to the base and each terminating in two ends, the first and second locking members each being capable of rotational movement about the base, the rotational movement defining a rotational footprint;
at least one end of at least one of the locking members allowing the at least one locking member to move substantially outside the rotational footprint;
wherein the first and second locking members together locking at least the following parts of the bipod to a rigid object: the front wheel, the rear wheel, and the frame.

2. The bipod lock of claim 1, wherein the first and second locking members each include a loop terminating in two ends.

3. The bipod lock of claim 2, wherein the ends of the first locking member are designed to be permanently attached to the base.

4. The bipod lock of claim 3, wherein a first end of the second locking member is designed to be permanently attached to the base, and a second end of the second locking member is detachable from the base.

5. The bipod lock of claim 4, wherein the second end of the second locking member is permanently attached to the base using a pivoting ball-and-socket joint.

6. The bipod lock of claim 3, wherein the ends of the second locking member are designed to be permanently attached to the base.

7. The bipod lock of claim 1, wherein the first and second locking members each include a loop-shaped member, and wherein the loop-shaped member of the first locking member is capable of nesting within the loop-shaped member of the second locking member.

8. The bipod lock of claim 2, wherein at least one end of at least one of the locking members can pivot relative to the base.

9. The bipod lock of claim 2, wherein the loops are each in the shape of an elongated arch.

10. The bipod lock of claim 2, wherein the base includes a locking mechanism enabling the locking and selective removal of at least one of the ends of each of the locking members, to and from the base.

11. The bipod lock of claim 10, wherein the locking mechanism only requires a single key.

12. A method for employing a bipod lock to securely lock a bipod to a rigid member, the bipod having bipod members comprising at least two wheels and a frame, comprising the steps of:
providing a bipod lock having a base, and first and second locking members connected to the base, the first and second locking members each being capable of rotational movement about the base, the rotational movement defining a rotational footprint, and at least one end of at least one of the locking members allowing the at least one locking member to move substantially outside the rotational footprint;
locking at least a bipod wheel to the rigid member using the first locking member; and
locking at least another bipod wheel and the frame of the bipod to the rigid member using the second locking member.

13. The method of claim 12, wherein the locking members each have two distal ends, and wherein the two distal ends of one of the locking members are removably connected to the base.

14. The method of claim 13, wherein the one of the two distal ends of the other locking member is permanently connected to the base.

15. The method of claim 14, wherein the permanent connection is achieved using a ball-and-socket joint.

16. The method of claim 13, wherein each of the two distal ends of the two locking members are pivotable relative to the base.

17. The method of claim 12, wherein the base employs a single keyhole for actuating a locking mechanism for securing the locking members to the base.

18. The method of claim 12, wherein the locking members each comprise elongated arch-shaped members.

19. The method of claim 12, wherein during the locking process the locking members are oriented to form an obtuse angle, and then locked in this position.

20. The method of claim 12, wherein during the locking process, further comprising the steps of ensuring that the locking members snugly fit the bipod members that they are securing.
